(19) United States
(12) Patent Application Publication
(10) Pub. No.: US 2026/0205784 A1
(43) Pub. Date: Jul. 16, 2026

(54) OUT-OF-BAND COMMUNICATION FOR ULTRA-WIDEBAND CONFIGURATION

(71) Applicant: Cisco Technology, Inc., San Jose, CA (US)

(72) Inventors: Niloofar BAHADORI, Greensboro, NC (US); Ardalan ALIZADEH, Campbell, CA (US); Peiman AMINI, Fremont, CA (US); Jerome HENRY, Pittsboro, NC (US)

(21) Appl. No.: 19/405,226

(22) Filed: Dec. 1, 2025

Related U.S. Application Data
(60) Provisional application No. 63/744,006, filed on Jan. 10, 2025.

(51) Int. Cl. H04W 4/80

(52) U.S. Cl. CPC H04W 4/80

(57) ABSTRACT

Described herein is a wireless network that uses out-of-band communications (e.g., Bluetooth) to configure UWB connections. A wireless access point includes a UWB radio, a Bluetooth radio, one or more memories, and one or more processors communicatively coupled to the one or more memories. The one or more processors, individually or collectively, perform an operation that includes storing a generic attribute (GATT) profile for establishing UWB communications, configuring, using the Bluetooth radio, a first UWB tag according to the GATT profile, and communicating, using the UWB radio, a UWB message to the first UWB tag after configuring the first UWB tag.

### CROSS-REFERENCE TO RELATED APPLICATIONS

This application claims benefit of co-pending United States provisional patent application Serial No. 63/744,006 filed January 10, 2025. The aforementioned related patent application is herein incorporated by reference in its entirety.

### TECHNICAL FIELD

Embodiments presented in this disclosure generally relate to wireless communication. More specifically, embodiments disclosed herein relate to using an out-of-band communication (e.g., Bluetooth) to configure ultra-wideband connections.

### BACKGROUND

Wireless communication systems (e.g., Wi-Fi networks) may use ultra-wideband (UWB) communications to perform ranging to determine the physical positions or locations of devices. These systems may communicate UWB radios to configure UWB connections with the devices and to perform ranging.

Relying solely on UWB for configuration and command control introduces significant challenges, particularly in power-constrained devices, such as phones and UWB tags. UWB radios may be more power-intensive, and frequent use for transmitting configuration data or commands may rapidly drain battery life, reducing the battery life of devices. Additionally, UWB may be optimized for high-precision ranging and positioning rather than low-bandwidth control messaging. Overloading UWB with lightweight commands or configuration data results in inefficient utilization of the UWB bandwidth, which is suitable for time-critical accurate ranging operations. This inefficiency may complicate system design and divert resources away from the primary role of the UWB, compromising its ability to deliver accurate and reliable ranging results.

Further, using UWB for control tasks may lead to unnecessary latency and channel congestion, particularly in dense deployments with multiple devices. Managing control messages and running operations on the same UWB channel increases the risk of conflicts, delaying critical time-sensitive measurements. The added complexity of integrating configuration and command tasks within UWB may also cause implementation challenges, as systems attempt to manage transitions between configuration and ranging states seamlessly. In scalable environments, contention for UWB access limits the system's ability to support many devices efficiently.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example component of the system of FIG. 1A.

FIG. 2 illustrates an example operation performed by the system of FIG. 1A.

FIG. 3 illustrates an example message used by the system of FIG. 1A.

FIG. 4 illustrates an example operation performed by the system of FIG. 1A.

FIG. 5 illustrates an example operation performed by the system of FIG. 1A.

FIG. 6 illustrates an example operation performed by the system of FIG. 1A.

FIG. 7 illustrates an example operation performed by the system of FIG. 1A.

FIG. 8 illustrates an example operation performed by the system of FIG. 1A.

FIG. 9 illustrates an example operation performed by the system of FIG. 1A.

FIG. 10 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a wireless network that uses out-of-band communications (e.g., Bluetooth) to configure UWB connections. According to an embodiment, a wireless access point includes a UWB radio, a Bluetooth radio, one or more memories, and one or more processors communicatively coupled to the one or more memories. The one or more processors, individually or collectively, perform an operation that includes storing a generic attribute (GATT) profile for establishing UWB communications, configuring, using the Bluetooth radio, a first UWB tag according to the GATT profile, and communicating, using the UWB radio, a UWB message to the first UWB tag after configuring the first UWB tag.

According to another embodiment, a method includes storing, by a wireless access point, a GATT profile for establishing UWB communications, configuring, using a Bluetooth radio of the wireless access point, a first UWB tag according to the GATT profile, and communicating, using a UWB radio of the wireless access point, a UWB message to the first UWB tag after configuring the first UWB tag.

According to another embodiment, a non-transitory computer readable medium stores instructions that, when executed by one or more processors, cause the one or processors to, individually or collectively, perform an operation that includes storing, by a wireless access point, a GATT profile for establishing UWB communications, configuring, using a Bluetooth radio of the wireless access point, a first UWB tag according to the GATT profile, and communicating, using a UWB radio of the wireless access point, a UWB message to the first UWB tag after configuring the first UWB tag.

### Example Embodiments

The present disclosure describes a wireless network that uses out-of-band communications (e.g., Bluetooth communications) to configure ultra-wideband (UWB) connections. Generally, a wireless access point may store a generic attribute (GATT) profile used to establish Bluetooth communication. The GATT profile may include additional parameters for UWB communication. The access point may use a Bluetooth radio of the access point and the GATT profile to communicate configuration messages that include parameters for a UWB session to a device (e.g., a UWB tag). After the UWB connection is established using the information from the GATT profile, the access point may communicate UWB messages (e.g., for ranging) to the device using a UWB of the access point.

In certain embodiments, the wireless network provides several technical advantages. For example, the wireless network may reduce latency and congestion on a UWB channel by communicating UWB configuration messages using an out-of-band communication. Additionally, the wireless network may reduce the use of UWB, which reduces power consumption and improves battery life.

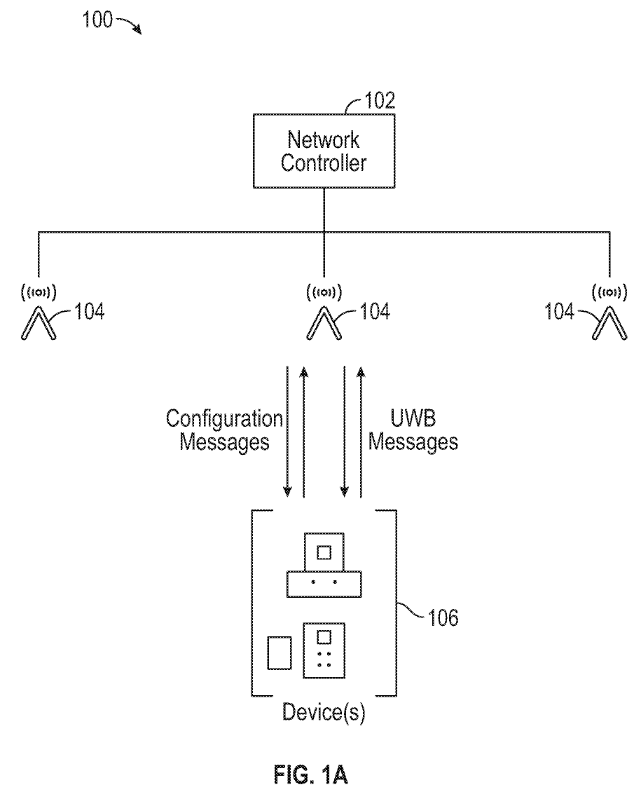

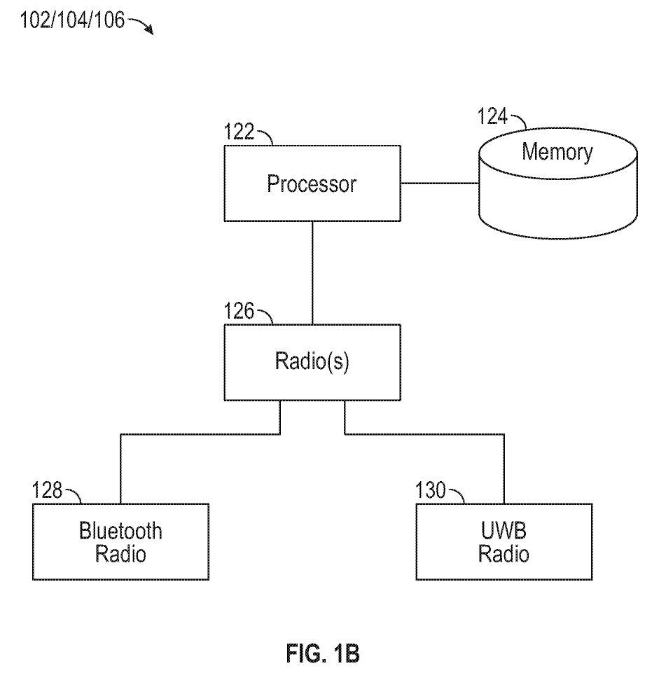

FIG. 1A illustrates an example system 100, which may be a wireless network. As seen in FIG. 1A, the system 100 includes a network controller 102, one or more access points 104, and one or more devices 106. Generally, the access points 104 may configure a UWB session with the device 106 (e.g., a UWB tag) and exchange UWB messages with the device 106 (e.g., to perform ranging) using different bands.

The network controller 102 facilitates or manages the communication in the system 100. As an example, the network controller 102 may manage the connections between the access points 104 and the devices 106. As another example, the network controller 102 may manage the connections and traffic between the access points 104.

An access point 104 may be a network device that facilitates wireless communication (e.g., Wi-Fi communication) in the system 100. The device 106 connects to the access point 104, and the access point 104 may facilitate communication to and from the device 106. For example, the access point 104 may receive messages from the device 106 and direct those messages towards their destination. As another example, the access point 104 may receive messages intended for the device 106 and direct those messages to the device 106. The access point 104 may also exchange messages with the network controller 102 and/or with other access points 104.

A device 106 may be any suitable device for communicating with components of the system 100. As an example and not by way of limitation, the device 106 may be a computer, a laptop, a wireless or cellular telephone, an electronic notebook, a personal digital assistant, a tablet, or any other device capable of receiving, processing, storing, or communicating information with other components of the system 100. The device 106 may be a wearable device such as a virtual reality or augmented reality headset, a smart watch, or smart glasses. The device 106 may also include a user interface, such as a display, a microphone, keypad, or other appropriate terminal equipment. The device 106 may include a hardware processor, memory, or circuitry configured to perform any of the functions or actions of the device 106 described herein. For example, a software application designed using software code may be stored in the memory and executed by the processor to perform the functions of the device 106.

The access points 104 may use UWB to perform ranging with the device 106 to determine a position or location of the device 106. Generally, the access points 104 may exchange configuration messages with the device 106 to establish a UWB session with the device 106. These configuration messages may include parameters that the access point 104 and the device 106 use to exchange UWB messages. After establishing the UWB session, the access point 104 and the device 106 exchange UWB messages. The access point 104 may use the UWB messages to determine the position or location of the device 106.

In some systems, the configuration messages and UWB messages are exchanged using the same communication band (e.g., a UWB band). As a result, the configuration messages consume a portion of the bandwidth that could otherwise be used for UWB messages. Additionally, exchanging the configuration messages consumes a large amount of electrical power of the access points and devices.

In the system 100, the access point 104 and the device 106 use a separate band to exchange the configuration messages. For example, the access point 104 and the device 106 may exchange configuration messages using a Bluetooth band, and the access point 104 and the device 106 may exchange UWB messages using a UWB band. Bluetooth is a low-power communication technology, making it beneficial for resource-constrained devices. Bluetooth is designed for efficient data transfer with low energy consumption, resulting in configuration commands and control tasks not draining a battery of the device 106 unnecessarily. Bluetooth also offers fast connection setup and reliable communication, which reduces latency and allows quick delivery of configuration messages. Additionally, Bluetooth is widely supported across platforms and ecosystems, allowing interoperability between devices 106 from different manufacturers. By leveraging Bluetooth, lightweight control messaging from UWB may be offloaded, allowing UWB to focus on the primary role of delivering high-precision ranging with minimal interference. In this manner, exchanging configuration messages may not consume bandwidth on the UWB band, and the access point 104 and the device 106 use less electrical power to exchange configuration messages.

FIG. 1B illustrates an example network controller 102, access point 104, or device 106 of the system 100 of FIG. 1A. As seen in FIG. 1B, the network controller 102, access point 104, or device 106 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), or state machines, that communicatively couples to the memory 124 and controls the operation of the network controller 102, access point 104, or device 106. The processor 122 may be 8-bit,16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the network controller 102, access point 104, or device 106 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the network controller 102, access point 104, or device 106 may use one or more of the radios 126 for Wi-Fi communications. The network controller 102, access point 104, or device 106 may use one or more of the radios 126 to transmit messages and one or more of the radios 126 to receive messages. The network controller 102, access point 104, or device 106 may include any number of radios 126 to communicate using any number of communication technologies.

As seen in FIG. 1B, the radios 126 may include radios that communicate over different bands. For example, the radios 126 may include a Bluetooth radio 128 that may be used to communicate over a Bluetooth band, and the radios 126 may include a UWB radio 130 that may be used to communicate over a UWB band. Generally, the network controller 102, access point 104, or device 106 may exchange UWB messages (e.g., to perform ranging) using the UWB band, and the network controller 102, access point 104, or device 106 may use a different band (e.g., the Bluetooth band) to configure or establish UWB sessions.

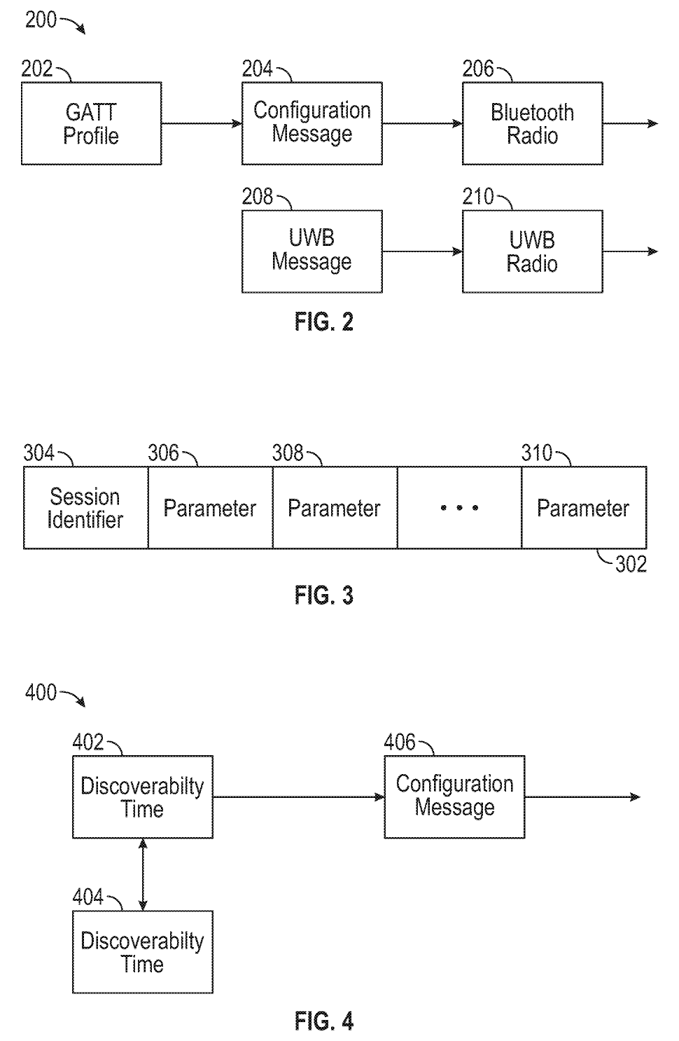

FIG. 2 illustrates an example operation 200 performed by the system 100 of FIG. 1A. Generally, an access point (e.g., the access point 104 shown in FIG. 1A) may perform the operation 200. By performing the operation 200, the access point establishes a UWB session and performs ranging using separate bands.

The access point begins by generating, maintaining, or storing a GATT profile 202 for UWB configuration and control. The GATT profile 202 provides a standardized way to handle communication between devices over Bluetooth. The GATT profile 202 indicates services and characteristics that allow the access point to configure UWB settings, to start or stop ranging operations, and to receive status updates. The GATT profile 202 may allow or provide for the following tasks: (i) sending configuration data to the device notifying the access point of the configuration status, and (ii) issuing commands to start or stop UWB ranging. By using the GATT profile 202, the access point provides an efficient, structured, and scalable solution for managing UWB control tasks through Bluetooth.

Generally, the GATT profile 202 specifies different parameters and the meanings for different values of the parameters. These parameters may be used to configure or establish UWB sessions and to specify the characteristics of UWB communications during the UWB sessions. For example, the GATT profile 202 may specify one or more channels to use for the UWB session (e.g., channel 5 or channel 9), a media access control (MAC) address of the device participating in the UWB session, a role of the device participating in the UWB session (e.g., responder, initiator, tag, etc.), a priority of the UWB session, a transmission interval for UWB messages, length of a randomization window, duration of ranging, and the number of slots during a ranging round. The GATT profile 202 may also specify a time interval between ranging frames (e.g., specified in milliseconds), a number of frames that form a burst, a maximum number of ranging measurements to be executed during a UWB session.

The access point generates a configuration message 204 using the information in the GATT profile 202. For example, the configuration message 204 may specify parameters for a UWB session (e.g., using the parameters and values in the GATT profile 202). The access point may send the configuration message 204 to a Bluetooth radio 206 of the access point. The access point may then communicate the configuration message 204 (e.g., to another device) using the Bluetooth radio 206. The device may then establish a UWB session with the access point using the information in the configuration message 204.

After the UWB session is established according to the parameters in the configuration message 204, the access point may generate a UWB message 208. The UWB message 208 may be used to perform UWB ranging with the device. The access point may send the UWB message 208 to a UWB radio 210, and the access point may use the UWB radio 210 to communicate the UWB message 208 to the device. The access point may measure the amount of time it takes to receive a response to the UWB message 208 from the device, which may indicate a position or location of the device. The access point may communicate any number of UWB messages 208 to the device using the UWB radio 210 during the UWB session. The number of UWB messages 208 may be guided by the parameters in the configuration message 204 and the GATT profile 202.

As seen in FIG. 2, the access point uses different bands to communicate the configuration message 204 and the UWB message 208. For example, the access point may use Bluetooth to communicate the configuration message 204 and UWB to communicate the UWB message 208. As a result, the access point uses different bands to establish UWB sessions and to perform ranging. In this manner, the access point frees up more bandwidth in the UWB band to perform ranging. Additionally, the access point reduces electrical power used to establish UWB sessions.

FIG. 3 illustrates an example message 302 used by the system 100 of FIG. 1A. Generally, the message 302 may be a configuration message that is used to establish an UWB session with a device. An access point (e.g., the access point 104 shown in FIG. 1A) may generate and communicate the message 302.

As seen in FIG. 3, the message 302 includes several fields that provide information to a receiving device. For example, the message 302 includes a field 304 that indicates a session identifier. The session identifier may be a sequence that identifies a UWB session established using the message 302.

The message 302 may include additional fields that specify parameters and the values for those parameters. In the example of FIG. 4, the message 302 includes fields 306, 308, and 310 that specify parameters and the values of those parameters. The parameters and the values may establish the characteristics of the UWB session. For example, the parameters may specify an amount of time between ranging frames, a number frames that form a burst, a maximum number of ranging measurements to be executed during the UWB session, etc. The message 302 may include any number of fields that indicate any number of parameters and values. By communicating the message 302 to a device, the access point may establish a UWB session with the device according to the parameters indicated in the message 302.

FIG. 4 illustrates an example operation 400 performed by the system 100 of FIG. 1A. Generally, an access point (e.g., the access point 104 shown in FIG. 1A) performs the operation 400. By performing the operation 400, the access point selects a device for establishing a UWB session.

Configuring multiple devices (e.g., UWB tags) poses challenges due to the limitations of Bluetooth connections, which may support only a limited number of concurrent connections. Furthermore, devices may become discoverable at random intervals, making it difficult to predict and coordinate the configuration process effectively. Without efficient connection management, many devices could miss their configuration windows, leading to significant delays.

The access point begins by determining discoverability times remaining for various devices in communication with the access point. For example, a first device may have a discoverability time 402 remaining, and a second device may have a discoverability time 404 remaining. The discoverability times 402 and 404 may indicate an amount of time remaining for the first and second devices to establish a UWB session with the access point.

The access point may prioritize devices with less discoverability time remaining (e.g., devices nearing the end of their cycle are prioritized). In the example of FIG. 4, the access point compares the discoverability time 402 to the discoverability time 404 to determine which of the first device and the second device has less discoverability time remaining. The access point may determine that the discoverability time 402 remaining for the first device is less than the discoverability time 404 remaining for the second device.

In response, the access point may generate a configuration message 406 for the first device. The configuration message 406 may specify parameters for a UWB session between the access point and the first device. The access point may communicate the configuration message 406 to the first device using a non-UWB band (e.g., Bluetooth). The first device may then establish a UWB session with the access point.

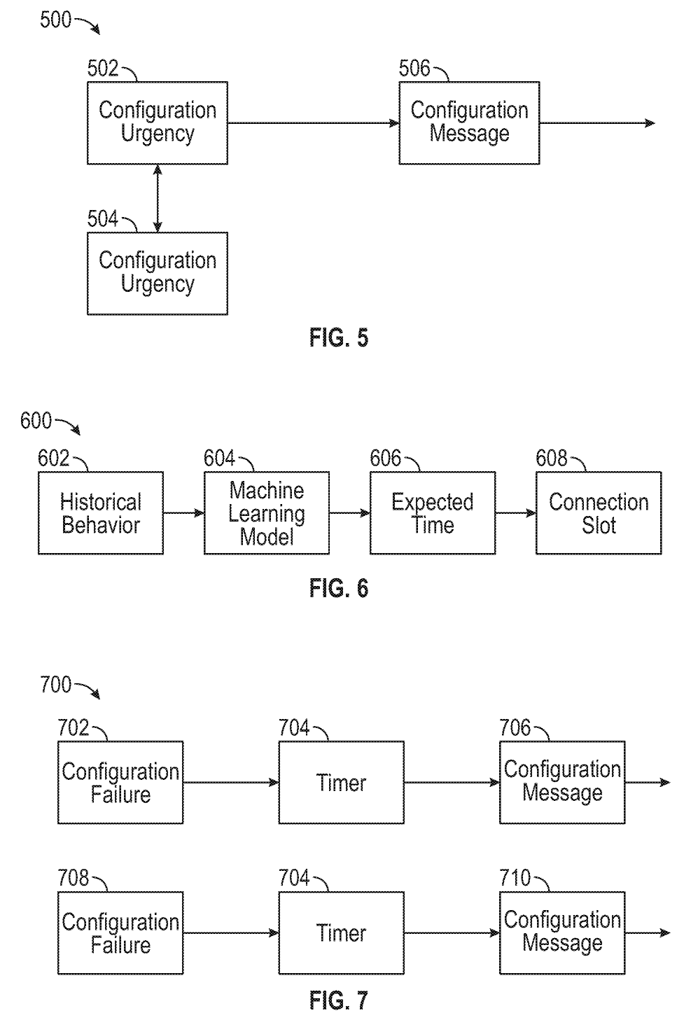

FIG. 5 illustrates an example operation 500 performed by the system 100 of FIG. 1A. Generally, an access point (e.g., the access point 104 shown in FIG. 1A) performs the operation 500. By performing the operation 500, the access point selects a device for establishing a UWB session.

The access point begins by determining a configuration urgency 502 for a first device and a configuration urgency 504 for a second device. The access point may prioritize devices with more or higher configuration urgency. For example, the access point may prioritize configuring devices that are critical for immediate operations. In the example of FIG. 5, the access point compares the configuration urgency 502 for the first device with the configuration urgency 504 for the second device to determine which of the first device and the second device has a higher configuration urgency. The access point may determine that the configuration urgency 502 for the first device is higher than the configuration urgency 504 for the second device.

In response, the access point may generate a configuration message 506 for the first device. The configuration message 506 may specify parameters for a UWB session between the access point and the first device. The access point may communicate the configuration message 506 to the first device using a non-UWB band (e.g., Bluetooth). The first device may then establish a UWB session with the access point.

In the examples of FIGS. 4 and 5, the access point selects a device for configuring a UWB session based on discoverability time or urgency. The access point, however, may select the device based on any criteria, including multiple factors (e.g., both discoverability time and urgency). In some instances, when a device becomes discoverable, the access point establishes a Bluetooth connection, performs service discovery, and transmits the configuration message. The connection may be terminated after receiving an acknowledgment to release the connection (e.g., GATT slot) for the next device. To reduce missed configuration opportunities, the access point may log discoverable devices that the access point could not serve within the active window and retries during the next cycle.

FIG. 6 illustrates an example operation 600 performed by the system 100 of FIG. 1A. Generally, an access point (e.g., the access point 104 shown in FIG. 1A) performs the operation 600. By performing the operation 600, the access point allocates connection slots for devices. To improve connection handling during bursts of discoverability, the access point may use a predictive model based on historical device behavior to pre-allocate connection slots for expected activity peaks.

The access point begins by determining historical behavior 602 of a device. The historical behavior 602 may indicate when the device previously established UWB sessions with the access points (or other access points). The access point may maintain a log of the historical behavior of the device, and the access point may reference the log to determine the historical behavior 602.

The access point inputs the historical behavior 602 to a machine learning model 604 to determine an expected time 606 when the device will establish a UWB session with the access point. The machine learning model 604 may be trained to analyze and detect patterns in the historical behavior 602, such as a pattern of when the device establishes UWB sessions and performs ranging. The machine learning model 604 may use this pattern to determine the expected time 606 when the device will establish a future UWB session with the access point.

The access point then sets or reserves a connection slot 608 (e.g., a Bluetooth connection slot) at the expected time 606. The access point may maintain the connection slot 608 at the expected time 606 so that the device may use the connection slot 608 to establish a UWB session with the access point at the expected time 606. The device may not be forced to wait for a connection slot to become available to establish the UWB session because the access point reserved the connection slot 608 for the device.

FIG. 7 illustrates an example operation 700 performed by the system 100 of FIG. 1A. Generally, an access point (e.g., the access point 104 shown in FIG. 1A) performs the operation 700. By performing the operation 700, the access point handles failures to establish UWB sessions. If interference or connection drops occur during configuration, the access point may queue a retry with adaptive timing to avoid channel congestion or device timeouts.

The access point begins by detecting a configuration failure 702 by a device. For example, interference or connection drops may have caused the device to experience the configuration failure 702 when attempting to establish a UWB session with the access point. In response to the configuration failure 702, the access point may start a timer 704 (e.g., so that the timer counts down). When the timer 704 expires, the access point generates or communicates a configuration message 706 to the device using a non-UWB band (e.g., Bluetooth). The configuration message 706 may attempt to establish a UWB session with the device.

The device may fail again to establish the UWB session (e.g., due to interference or connection drop). The access point may detect a configuration failure 708 that indicates that the device failed to establish the UWB session using the configuration message 706. In response, the access point may start the timer 704 (e.g., so that the timer counts down). When the timer 704 expires, the access point generates or communicates a configuration message 710 to the device using a non-UWB band (e.g., Bluetooth). The configuration message 710 may attempt to establish a UWB session with the device. In some instances, the access point may set the timer 704 to a higher value in response to detecting the configuration failure 708 than in response to detecting the configuration failure 702. The access point may increase the value of the timer 704 for subsequent retries to establish the UWB session. In this manner, the access point may increase the delay between retry attempts.

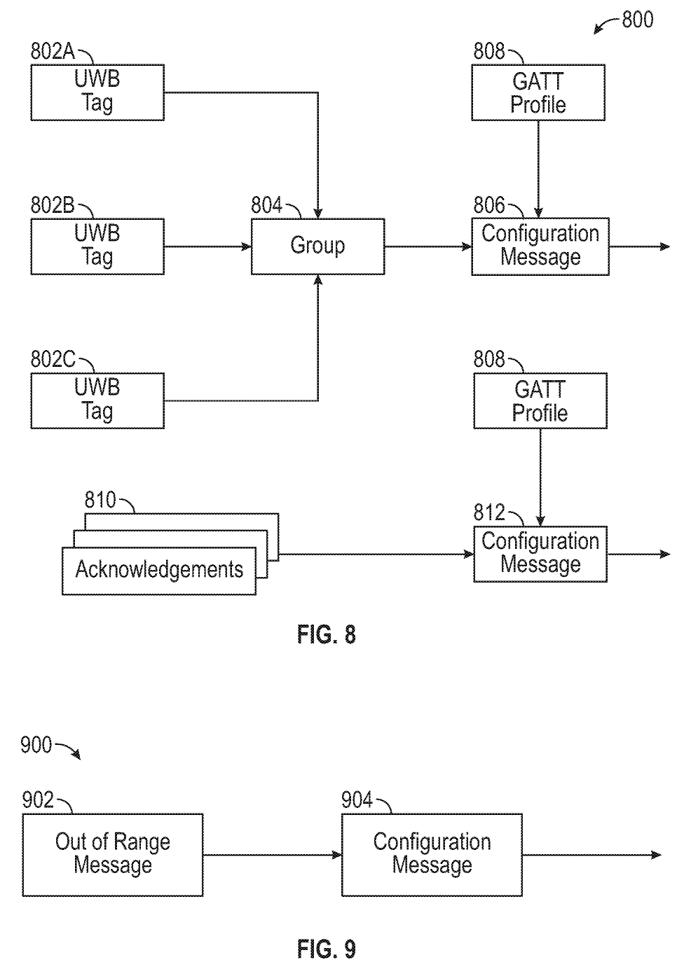

FIG. 8 illustrates an example operation 800 performed by the system 100 of FIG. 1A. Generally, an access point (e.g., the access point 104 shown in FIG. 1A) performs the operation 800. By performing the operation 800, the access point establish UWB sessions for groups of devices. In enterprise environments, it may be common for multiple devices to share identical configuration requirements, such as UWB operational parameters. Configuring these devices individually by establishing separate Bluetooth connections for each devices may introduce unnecessary delays and may increase connection overhead. Additionally, providing reliable receipt of configuration updates across all tags may add complexity in environments with overlapping coverage or radio frequency interference.

The access point begins by grouping multiple devices. For example, the access point may assign UWB tags 802A, 802B, and 802C to a group 804. As a result, each UWB tag 802A, 802B, and 802C may be assigned the same group identifier. The access point then generates and broadcasts a configuration message 806 (e.g., using a non-UWB band). The configuration message 806 may include parameters and values from a GATT profile 808. By broadcasting the configuration message 806, the access point may communicate the configuration message 806 to one or more of the UWB tags 802A, 802B, and 802C.

The access point may then receive acknowledgements 810 from the UWB tags that received the configuration message 806. Each UWB tag that received the configuration message 806 may communicate an acknowledgement 810 to the access point. The access point may then establish UWB sessions with these UWB tags.

In some instances, a UWB tag may not receive the configuration message 806 and may not communicate the acknowledgement 810 to the access point. The access point may track from which UWB tags the access point did not receive an acknowledgement 810. The access point may then retry establishing UWB sessions with these UWB tags. As seen in FIG. 8, the access point may generate and communicate a configuration message 812 to the UWB tags from which the access point did not receive an acknowledgement 810 (e.g., using a non-UWB band). The configuration message 812 may include parameters and values from the GATT profile 808. The access point may then communicate the configuration message 812 to the UWB tags from which the access point did not receive the acknowledgement 810 (e.g., by broadcasting the configuration message 812). In some instances, the access point may communicate individual configuration messages 812 to the UWB tags separately rather than broadcasting the configuration message 812.

As an example, the access point may broadcast the configuration message 806 to the UWB tags 802A, 802B, and 802C. The access point may receive acknowledgements 810 from the UWB tags 802A and 802B but not the UWB tag 802C. The access point may determine that the access point did not receive an acknowledgement 810 from the UWB tag 802C. In response, the access point generates and communicates the configuration message 812 to the UWB tag 802 (e.g., through broadcast or direct communication). The access point may then receive an acknowledgement 810 from the UWB tag 802C, which establishes the UWB session with the UWB tag 802C.

In some instances, the configuration message 806 or 812 may include a version number so that the UWB tags apply updates (e.g., if the version number is later or higher than a previously received version number). An acknowledgement 810 may include an identifier for the UWB tag that communicated the acknowledgement and a status of establishing the UWB session (e.g., success or failure). In certain instances, to prevent acknowledgement collisions, the UWB tags may use randomized backoff timers for initiating Bluetooth connections with the access point. If a UWB tag fails to receive the broadcast or apply the configuration, the UWB tag may retry during subsequent advertisement cycles. The access point may track unacknowledged tags for follow-ups and targeted reconfiguration. For environments with overlapping access point coverage, the configuration messages may include metadata to prevent duplicate configurations from neighboring access points.

FIG. 9 illustrates an example operation 900 performed by the system 100 of FIG. 1A. Generally, an access point (e.g., the access point 104 shown in FIG. 1A) performs the operation 800. By performing the operation 800, the access point establishes UWB sessions with devices that may be out of range. In large-scale deployments, devices may be distributed across areas that exceed the direct communication range of a single access point. Configuring these devices directly may result in either increasing access point density, which raises deployment costs, or relying on suboptimal mechanisms that may leave some devices unconfigured. Additionally, as the number of devices grows, the access point may struggle to handle the configuration load alone, leading to delays and inefficiencies.

The access point may use certain devices within range of the access point as relay nodes that relay or forward configuration messages to other devices that are out of range of the access point. The access point may begin by receiving an out of range message 902 from a first device in range of the access point. The out of range message 902 may indicate a second device that is out of range of the access point.

To configure the second device, the access point may generate and communicate, to the first device, a configuration message 904 to configure the second device. The configuration message 904 may include an instruction or identifier that indicates that the configuration message 904 should be communicated to the second device. When the first device receives the configuration message 904, the first device may relay or forward the configuration message 904 to the second device. The second device may then accept the configuration to establish a UWB session with the access point through the first device.

During the discovery phase, the access point assesses the signal strength of nearby devices and selects a subset as relay nodes. Criteria for selection may include: proximity to unconfigured devices, signal quality, battery availability (e.g., devices with higher power levels are preferred). The access point may configure relay nodes first and provide the relay nodes with instructions to propagate configuration data to other devices. Relay nodes may be assigned unique relay identifiers and time slots to prevent collisions.

Relay nodes broadcast configuration payloads using Bluetooth advertising channels and establish short Bluetooth connections with nearby unconfigured devices. Each configured device sends an acknowledgment back to its relay node. Relay nodes periodically synchronize with the access point to provide aggregated acknowledgment data and report any unconfigured devices. If unconfigured devices remain, the access point may dynamically assign new relay nodes to cover those areas.

For dynamic environments, such as moving devices, relay nodes may monitor UWB ranging data to adjust propagation targets in real-time, which may allow mobile devices to be configured effectively. To handle interference or overlapping relay nodes, a time-division scheme may be used, where relay nodes operate in staggered slots to avoid channel contention.

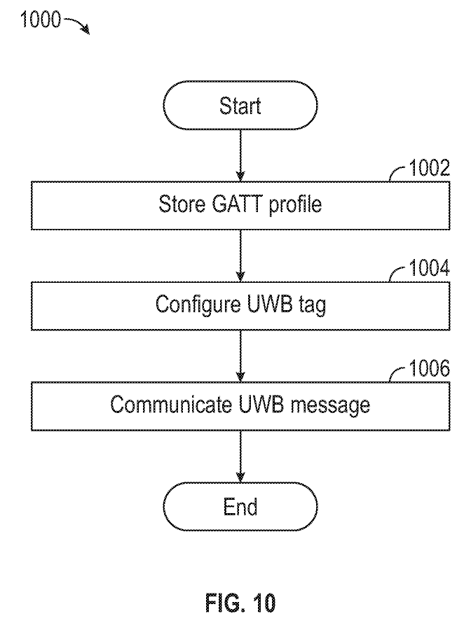

FIG. 10 is a flowchart of an example method 1000 performed by the system 100 of FIG. 1A. In certain embodiments, an access point (e.g., the access point 104 shown in FIG. 1A) performs the method 1000. By performing the method 1000, the access point uses a non-UWB band to establish a UWB session with a device (e.g., a UWB tag).

At 1002, the access point stores a GATT profile. The GATT profile may include or indicate various parameters for establishing a UWB session with the access point. For example, the GATT profile may indicate a time interval between ranging frames, a number of frames that form a burst, and a maximum number of ranging measurements per UWB session.

At 1004, the access point may configure a UWB tag. For example, the access point may generate a configuration message using the information in the GATT profile. The access point may then communicate the configuration message to the UWB tag using a non-UWB band. For example, the access point may communicate the configuration message using a Bluetooth radio to the UWB tag. The UWB tag may then use the configuration message to establish a UWB session with the access point.

At 1006, the access point communicates a UWB message to the UWB tag during the UWB session. The access point may use a UWB radio to communicate the UWB message in a UWB band. The access point and the UWB tag may use the UWB message to perform ranging. The access point may determine the position or location of the UWB tag using the UWB message.

In summary, wireless network uses out-of-band communications (e.g., Bluetooth communications) to configure ultra-wideband (UWB) connections. A wireless access point 104 may store a GATT profile used to establish Bluetooth communication. The GATT profile may include additional parameters for UWB communication. The access point 104 may use a Bluetooth radio of the access point 104 and the GATT profile to communicate configuration messages that include parameters for a UWB session to a device (e.g., a UWB tag). After the UWB connection is established using the information from the GATT profile, the access point 104 may communicate UWB messages (e.g., for ranging) to the device using a UWB of the access point 104.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless access point comprising:
an ultra-wideband (UWB) radio;
a Bluetooth radio;
one or more memories; and
one or more processors communicatively coupled to the one or more memories, wherein the one or more processors are configured to, individually or collectively, perform an operation comprising:
storing a generic attribute (GATT) profile for establishing UWB communications;
configuring, using the Bluetooth radio, a first UWB tag according to the GATT profile; and
communicating, using the UWB radio, a UWB message to the first UWB tag after configuring the first UWB tag.

2. The wireless access point of claim 1, wherein configuring the first UWB tag comprises:
determining a first remaining discoverability time for the first UWB tag and a second remaining discoverability time for a second UWB tag; and
prioritizing the first UWB tag for configuration over the second UWB tag based on the first remaining discoverability time being less than the second remaining discoverability time.

3. The wireless access point of claim 1, wherein configuring the first UWB tag comprises prioritizing the first UWB tag for configuration based on a configuration urgency of the first UWB tag.

4. The wireless access point of claim 1, wherein configuring the first UWB tag comprises:
determining, using a machine learning model, an expected time when the first UWB tag will request to be configured; and
allocating a connection for the first UWB tag at the expected time.

5. The wireless access point of claim 1, wherein configuring the first UWB tag comprises:
determining that a first attempt to configure the first UWB tag failed;
starting a timer at a first value based on the first attempt failing;
making a second attempt to configure the first UWB tag after the timer expires;
determining that the second attempt failed; and
starting the timer at a second value greater than the first value based on the second attempt failing.

6. The wireless access point of claim 1, wherein the operation comprises:
assigning a plurality of UWB tags to a group, wherein the group is identified using a group identifier;
broadcasting, using the Bluetooth radio, a first configuration message comprising the group identifier according to the GATT profile; and
receiving, from the plurality of UWB tags, a plurality of acknowledgements to the first configuration message.

7. The wireless access point of claim 6, wherein the operation comprises:
assigning a third UWB tag to the group;
determining that an acknowledgement to the first configuration message was not received from the third UWB tag; and
communicating a second configuration message to the third UWB tag according to the GATT profile based on determining that an acknowledgement to the first configuration message was not received from the third UWB tag.

8. The wireless access point of claim 1, wherein the operation comprises:
receiving, from the first UWB tag, a message indicating that a second UWB tag is outside a range of the wireless access point; and
communicating a configuration message according to the GATT profile to the first UWB tag, such that the first UWB tag relays the configuration message to the second UWB tag.

9. The wireless access point of claim 1, wherein the GATT profile comprises a first parameter indicating a number of UWB messages forming a burst, a second parameter indicating an amount of time between transmissions of bursts, and a third parameter indicating a maximum number of ranging measurements to be performed in a session.

10. A method comprising:
storing, by a wireless access point, a GATT profile for establishing UWB communications;
configuring, using a Bluetooth radio of the wireless access point, a first UWB tag according to the GATT profile; and
communicating, using a UWB radio of the wireless access point, a UWB message to the first UWB tag after configuring the first UWB tag.

11. The method of claim 10, wherein configuring the first UWB tag comprises:
determining a first remaining discoverability time for the first UWB tag and a second remaining discoverability time for a second UWB tag; and
prioritizing the first UWB tag for configuration over the second UWB tag based on the first remaining discoverability time being less than the second remaining discoverability time.

12. The method of claim 10, wherein configuring the first UWB tag comprises prioritizing the first UWB tag for configuration based on a configuration urgency of the first UWB tag.

13. The method of claim 10, wherein configuring the first UWB tag comprises:
determining, using a machine learning model, an expected time when the first UWB tag will request to be configured; and
allocating a connection for the first UWB tag at the expected time.

14. The method of claim 10, wherein configuring the first UWB tag comprises:
determining that a first attempt to configure the first UWB tag failed;
starting a timer at a first value based on the first attempt failing;
making a second attempt to configure the first UWB tag after the timer expires;
determining that the second attempt failed; and
starting the timer at a second value greater than the first value based on the second attempt failing.

15. The method of claim 10, further comprising:
assigning a plurality of UWB tags to a group, wherein the group is identified using a group identifier;
broadcasting, using the Bluetooth radio, a first configuration message comprising the group identifier according to the GATT profile; and
receiving, from the plurality of UWB tags, a plurality of acknowledgements to the first configuration message.

16. The method of claim 15, further comprising:
assigning a third UWB tag to the group;
determining that an acknowledgement to the first configuration message was not received from the third UWB tag; and
communicating a second configuration message to the third UWB tag according to the GATT profile based on determining that an acknowledgement to the first configuration message was not received from the third UWB tag.

17. The method of claim 10, further comprising:
receiving, from the first UWB tag, a message indicating that a second UWB tag is outside a range of the wireless access point; and
communicating a configuration message according to the GATT profile to the first UWB tag, such that the first UWB tag relays the configuration message to the second UWB tag.

18. The method of claim 10, wherein the GATT profile comprises a first parameter indicating a number of UWB messages forming a burst, a second parameter indicating an amount of time between transmissions of bursts, and a third parameter indicating a maximum number of ranging measurements to be performed in a session.

19. A non-transitory computer readable medium storing instructions that, when executed by one or more processors, cause the one or processors to, individually or collectively, perform an operation comprising:
storing, by a wireless access point, a GATT profile for establishing UWB communications;
configuring, using a Bluetooth radio of the wireless access point, a first UWB tag according to the GATT profile; and
communicating, using a UWB radio of the wireless access point, a UWB message to the first UWB tag after configuring the first UWB tag.

20. The medium of claim 19, wherein configuring the first UWB tag comprises:
determining a first remaining discoverability time for the first UWB tag and a second remaining discoverability time for a second UWB tag; and
prioritizing the first UWB tag for configuration over the second UWB tag based on the first remaining discoverability time being less than the second remaining discoverability time.
